(19) United States
(12) Patent Application Publication
(10) Pub. No.: US 2004/0170192 A1
(43) Pub. Date: Sep. 2, 2004

(54) Method of transmitting data packets

(76) Inventor: Christoph Herrmann, Aachen (DE)

Correspondence Address: Corporate Patent Counsel, Philips Electronics North America Corporation, P O Box 3001, Briarcliff Manor, NY, 10510, US

(21) Appl. No.: 10/482,884

(22) PCT Filed: Jul. 5, 2002
(86) PCT No.: PCT/IB02/02834

(30) Foreign Application Priority Data
Jul. 10, 2001 (DE) 101 32 577.0

(51) Int. Cl. H04J 3/24

(52) U.S. Cl. 370/473; 370/477; 714/749

(57) ABSTRACT

The invention relates to a method of transmitting data packets between a transmitter and a receiver, wherein the receiver is designed for sending a positive acknowledge message to the transmitter when a data packet is received free from errors, wherein the receiver is designed for sending a negative acknowledge message to the transmitter when a data packet is received with errors, wherein the receiver is designed for sending a repeat message to the transmitter for requesting a repeated transmission of a data packet if no repeated transmission of the relevant data packet takes place in spite of a negative acknowledge message sent by the receiver, and wherein the transmitter is designed for the repeated transmission of a data packet whenever the transmitter has received a negative acknowledge message or a repeat message.

The invention relates to a method of transmitting data packets between a transmitter and a receiver.

Such a method is known, for example, from the document “Tdoc 12A010024, Signaling and Timing Considerations for HS-DSCH, Source: Lucent Technologies, 3GPP TSG RAN WG1 & WG2 meeting on HSDPA, Sophia Antipolis, Apr. 5-6, 2001”.

In this known method, the receiver sends a positive acknowledge message to the transmitter when it has received a data packet free from errors, and a negative acknowledge message to the transmitter when it has received a data packet with errors.

If the transmitter has received a positive acknowledge message, it continues by sending a new data packet.

If the transmitter has received a negative acknowledge message, it will send the relevant data packet once more.

If the transmitter erroneously interprets a negative acknowledge message sent by the receiver as a positive acknowledge message and accordingly continues by sending a new data packet, the information of the data packet received with errors by the receiver and subject of a negative acknowledge message, erroneously interpreted by the transmitter as a positive acknowledge message, will be lost.

It is an object of the invention to provide a method with an improved error treatment as well as a data transmission system for this purpose.

As regards the method, this object is achieved by means of a method of transmitting data packets between a transmitter and a receiver, wherein the receiver is designed for sending a positive acknowledge message to the transmitter when a data packet is received free from errors, wherein the receiver is designed for sending a negative acknowledge message to the transmitter when a data packet is received with errors, wherein the receiver is designed for sending a repeat message to the transmitter for requesting a repeated transmission of a data packet if no repeated transmission of the relevant data packet takes place in spite of a negative acknowledge message sent by the receiver, and wherein the transmitter is designed for the repeated transmission of a data packet whenever the transmitter has received a negative acknowledge message or a repeat message.

The invention is based on the idea of providing a possibility of a renewed transmission of the data packet in question also if a negative acknowledge message sent by the receiver was deformed into a positive acknowledge message on its transmission path or was erroneously interpreted as a positive acknowledge message by the transmitter.

It is provided for this purpose that the receiver sends a repeat message to the transmitter if no renewed transmission of the relevant data packet has taken place in spite of a negative acknowledge message sent by the receiver, and the transmitter has sent a new data packet instead of the desired repeat transmission of the erroneously received data packet.

The repeat message notifies the transmitter that it should once more send the data packet of the preceding transmission period, whereas the negative acknowledge message notifies the transmitter that it should once more send the data packet of the current transmission period.

The transmission period is considered to be the time period between the sending of a data packet and the reception of a positive or negative acknowledge message or a repeat message.

In the advantageous embodiment of the invention defined in claim 2, those data packets for which the transmitter has received a positive acknowledge message are put into intermediate storage by the transmitter for at least one further transmission period. The reception of a positive acknowledge message is understood to mean that the transmitter has interpreted a received acknowledge signal as a positive acknowledge signal. The corresponding data packet will then still be in the memory during the subsequent transmission period and may be sent once more by the transmitter without problems if it should receive a repeat message.

In the advantageous embodiment of the invention as defined in claim 3, the data packets are each transmitted with a sequence number. This is preferably a 1-bit sequence number. The transmitter changes the sequence number whenever it receives a positive acknowledge message for a transmitted data packet. A new data packet with the changed sequence number will be sent after reception of the positive acknowledge message.

This renders it possible for the receiver to distinguish between a first-time transmission of a data packet and a repeat transmission of a data packet

In the advantageous embodiment of the invention as defined in claim 4, the positive and negative acknowledge messages also have sequence numbers.

In the advantageous embodiment of the invention as defined in claim 5, a time frame structure is provided for transmitting the data packets. The time frame structure may comprise one or several time frames. A time frame comprises a number N of time slots, each time slot being reserved for the transmission of one data packet. A time frame is reserved for the transmission of data packets between one transmitter and one receiver. The time frames are preferably repeated at given time distances. For example, if two time frames are provided, the first time frame may be used for the transmission between a first transmitter and a first receiver, and the second time frame for the transmission between the first transmitter and a second receiver or for the transmission between a second transmitter and the first receiver.

The time frame structure is implemented both at the transmitter side and at the receiver side and is accordingly synchronized. This means that the positive and negative acknowledge messages as well as the repeat messages are sent in the respective time slots of the time frame.

The advantageous embodiment of the invention as defined in claim 6 relates to the case in which a negative acknowledge message was falsely converted into a positive acknowledge message.

After sending the negative acknowledge message, the receiver will accordingly not receive the expected repeat of the previously erroneously received data packet, but the first-time transmission of a new, unexpected data packet. The latter is nevertheless put into intermediate storage, so that a repeat transmission of this unexpected data packet is rendered unnecessary.

The advantageous embodiment of the invention as defined in claim 7 relates to the case in which a positive acknowledge message was falsely converted into a negative acknowledge message.

After sending the positive acknowledge message, accordingly, the receiver does not receive the expected first-time transmission of a new data packet, but the repeat transmission of the previously correctly received data packet. Since this is already present in the receiver, it is rejected and not put into the memory.

In the advantageous embodiment of the invention as defined in claim 8, two different repeat messages are provided. The distinction between the first and the second repeat message may be made by means of a 1-bit coding.

The first repeat message is sent by the receiver whenever it has received a data packet with errors in the previous transmission period and has accordingly sent a negative acknowledge message, but the transmitter has not transmitted this data packet once more, but has sent a new, i.e. unexpected data packet, which packet was correctly received by the receiver. The receiver thus at the same time sends a positive acknowledge message for the unexpected data packet to the transmitter.

The second repeat message is sent by the receiver whenever it has received a data packet with errors in the previous transmission period and has accordingly sent a negative acknowledge message, but the transmitter has not transmitted this data packet once more but has sent a new, i.e. unexpected data packet which was received with errors by the receiver. The receiver thus at the same time sends a negative acknowledge message for the unexpected data packet to the transmitter.

As regards the data transmission system, the object of the invention is achieved by means of a data transmission system comprising a transmitter and a receiver and means for transmitting data packets between the transmitter and the receiver, wherein the receiver is designed for sending a positive acknowledge message to the transmitter when a data packet is received free from errors, wherein the receiver is designed for sending a negative acknowledge message to the transmitter when a data packet is received with errors, wherein the receiver is designed for sending a repeat message to the transmitter for requesting a repeated transmission of a data packet if no repeated transmission of the relevant data packet takes place in spite of a negative acknowledge message sent by the receiver, and wherein the transmitter is designed for the repeated transmission of a data packet whenever the transmitter has received a negative acknowledge message or a repeat message.

An embodiment of the invention will be explained in more detail below with reference to the Figures, in which:

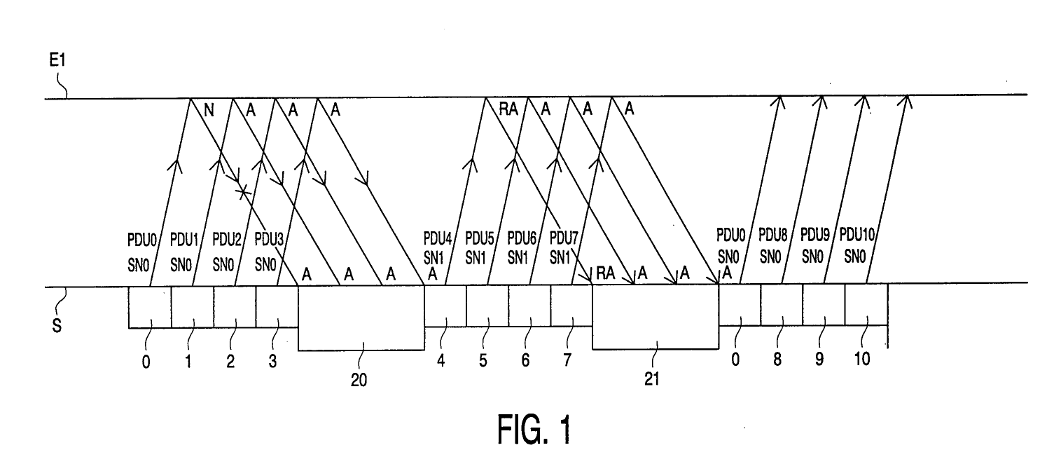

FIG. 1 diagrammatically shows the time sequence of a first data transmission between a transmitter and a receiver, and

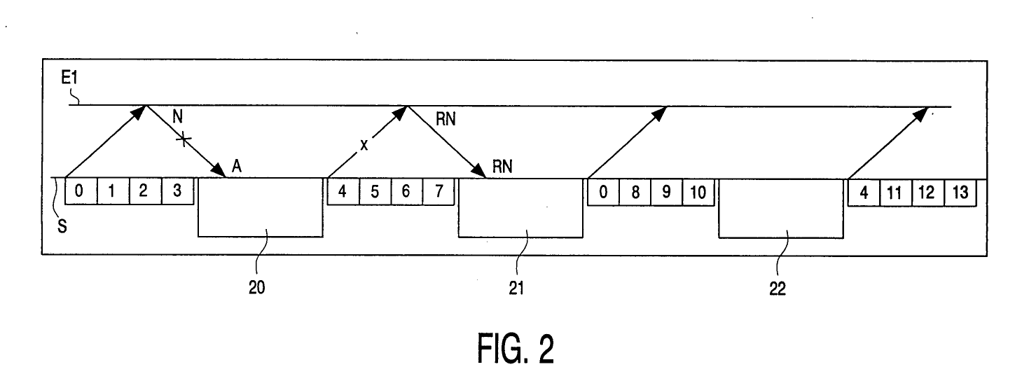

FIG. 2 diagrammatically shows the time sequence of a second data transmission between the transmitter and the receiver.

FIG. 1 diagrammatically shows the time sequence of a data transmission between a transmitter S and a receiver E1. The transmitter S may be, for example, a base station of a mobile telephone network, and the receiver E1 may be a mobile station or terminal of this mobile telephone network. A time frame structure similar to a time multiplexing system (TDMA: Time Division Multiple Access) is provided for the transmission of data packets between the transmitter and the receiver. Four consecutive time slots, and accordingly four channels, are provided for the transmission between the transmitter S and the receiver E1 within the time frame structure. After every four consecutive time slots, a time phase follows which is reserved for the transmission between the transmitter S and further receivers E2, E3, . . . , for example other mobile stations which are not shown. This time phase may be utilized in the same manner as the time phase provided for the transmission between the transmitter S and the receiver E1 and will accordingly not be described any further.

The data transmission shown in FIG. 1 comprises a first time frame which contains the time slots 0, 1, 2, and 3. Each of the time slots 0 to 3 is reserved for the transmission of a corresponding data packet PDU 0 to PDU 3 (PDU: Packet Data Unit), i.e. the data packet PDU 0 is transmitted in the time slot 0, the data packet PDU 1 in the time slot 1, the data packet PDU 2 in the time slot 2, and the data packet PDU 3 in the time slot 3. The data packets are each transmitted with a 1-bit sequence number. This 1-bit sequence number enables the receiver to distinguish between a first-time transmission of a data packet and a repeat transmission of a data packet. The data packets PDU 0 to PDU 3 are transmitted in combination with the sequence number 0 in the embodiment each time.

The receiver E1 tests whether the incoming data packets have been received with errors or without errors. If the receiver E1 has received a data packet without errors, it sends a positive acknowledge message A to the transmitter S. If the receiver has received a data packet with errors, it sends a negative acknowledge message N to the transmitter S.

The sending of the positive and negative acknowledge messages takes place, shifted in time, in a similar manner, also in time slots which are not shown. The transmitter and receiver operate in a synchronized manner as regards the sending/receiving of the data packets and the associated positive and negative acknowledge messages.

The time slots 0, 1, 2, and 3 are followed by a time phase 20 which is reserved for a data transmission between the transmitter S and further receivers E2, E3, . . . . The transmitter S receives the positive or negative acknowledge messages from the receiver E1 during this time phase 20.

In the embodiment, the receiver E1 has received the data packet PDU 0 with errors and the data packets PDU 1 to PDU 3 without errors. Accordingly, the receiver E1 sends a negative acknowledge message N for the data packet PDU 0 and a positive acknowledge message A for the data packets PDU 1 to PDU 3 back to the transmitter S. A transmission error occurs in the transmission of the negative acknowledge message N, which has the result that the transmitter S wrongly interprets the negative acknowledge message N sent by the receiver E1 as a positive acknowledge message A. The positive acknowledge messages A sent in reply to the data packets PDU 1 to PDU 3 are correctly received by the transmitter S.

The transmitter S now assumes that all data packets PDU 0 to PDU 3 have arrived at the receiver E1 without errors. Accordingly, it sends new data packets PDU 4 to PDU 7 to the receiver E1 in the subsequent time slots 4 to 7.

Since the data packets PDU 4 to PDU 7 are new data packets sent for the first time, the transmitter S changes the sequence number sent along with the respective data packet. Since the PDUs 0 to 3 were each sent with the sequence number 0 in the preceding transmission phase, the data packets PDU 4 to PDU 7 are now sent with the sequence number 1 to the receiver E1.

Nevertheless, the transmitter S stores the data packets PDU 0 to PDU 3 for a further transmission period so as to ensure that a repeat transmission of the data packets PDU 0 to PDU 3 is possible in the case of an incorrect interpretation of the positive acknowledge messages. The transmission period is understood to be the time period between the transmission of a data packet and the reception of a positive or negative acknowledge message or a repeat message.

The new data packets PDU 4 to PDU 7 are correctly received by the receiver E1. The receiver E1, however, expects a repeat transmission of the data packet PDU 0 instead of the first-time transmission of the data packet PDU 4, since PDU 0 was incorrectly received in the preceding transmission period and a negative acknowledge message was sent in response to it. The receiver E1 recognizes from the sequence number 1 that the data packet PDU 4 is a first-time transmission of the data packet PDU 4 and not a repeat transmission of the data packet PDU 0, because the data packet PDU 0 would have been sent with the sequence number 0 again in the case of a repeat transmission. To request a renewed transmission of the data packet PDU 0, the receiver E1 sends a repeat message RA to the transmitter S. The data packets PDU 4 to PDU 7, which were received free from errors, are put into temporary storage by the receiver E1, because the data packet PDU 0 is lacking at the moment, so as to be able to supply the data packets in a correct rising, uninterrupted sequence to a higher layer.

Two different repeat messages are provided in the data transmission system. The first repeat message is a signal RA (Revert Acknowledgement) for the positive acknowledgement of a non-expected data packet and for requesting a renewed transmission of the expected data packet. The second repeat message is a signal RN (Revert Negative acknowledgement) for the negative acknowledgement of a non-expected data packet and for requesting a renewed transmission of the expected data packet.

In the present example, the data packet PDU 4 was not expected by the receiver E1, but it was received free from errors. The receiver E1 accordingly sends the signal RA in response to the received data packet PDU 4, thus notifying the transmitter that a repeat transmission of the preceding data packet PDU 0 is desired, but that the data packet PDU 4 was received without errors.

The data packets PDU 5 to PDU 7 were received free from errors by the receiver E1, and a positive acknowledge message A is accordingly sent to the transmitter S for these data packets PDU 5 to PDU 7.

The time slots 4, 5, 6, and 7 are followed by a time phase 21 which is reserved for a data transmission between the transmitter S and further receivers E2, E3, . . . . Within this time phase 21, the transmitter S receives from the receiver E1 a positive acknowledge message A for the data packets PDU 5 to 7 and the repeat message RA for the data packets PDU 0 and PDU 4.

The transmitter S now assumes that all data packets PDU 4 to PDU 7 have arrived without errors at the receiver E1 and that the data packet PDU 0 has arrived with errors and should be sent once more. Accordingly, it first sends the PDU 0 once more in the subsequent time slot 0 and new data packets PDU 8 to PDU 10 in the subsequent time slots 8, 9, and 10 to the receiver E1.

The repeat transmission of the data packet PDU 0 is done with the sequence number 0 because the first transmission of PDU 0 also had the sequence number 0.

Since the data packets PDU 8 to PDU 10 are new data packets sent for the first time, the transmitter S changes the sequence number sent along with the data packets. Since the PDUs 4 to 7 were each sent with the sequence number 1 in the preceding transmission phase, the data packets PDU 8 to PDU 10 are now sent to the receiver E1 with the sequence number 0.

The transmitter S stores the data packets PDU 5 to PDU 7 for a further transmission period for the eventuality that it has wrongly interpreted the positive acknowledge messages A for the PDUs 5 to 7 or that a transmission error has occurred in the transmission of these positive acknowledge messages. It is accordingly capable of carrying out a repeat transmission of these PDUs 5 to 7 if it receives a repeat message from the receiver E1 in the next transmission period.

The data transmission between the transmitter S and the receiver E1 is continued periodically in the same manner after that.

FIG. 2 diagrammatically shows the time sequence of a data transmission between a transmitter S and a receiver E1. The data transmission corresponds to a large extent to the data transmission of FIG. 1, which is why FIG. 2 only shows the data transmissions for the respective first time slots 0, 4, 0, and 4 of the time frames reserved for the transmission between the transmitter S and the receiver E1. The differences with the data transmission diagram of FIG. 1 will be clarified below. In the data transmission of FIG. 2, an error occurs in the first-time transmission of the data packet PDU 4 not expected by the receiver E1, i.e. the receiver E1 receives the data packet PDU 4 with errors. The receiver E1 therefore sends the repeat message RN for the wrongly received data packet PDU 4, notifying the transmitter that a repeat transmission of the preceding data packet PDU 0 is desired and that the data packet PDU 4 was received with errors and accordingly a repeat transmission of the data packet PDU 4 is also desired.

A repeat transmission of the data packet PDU 0 accordingly takes place in the next transmission period, and in the transmission period after that a repeat transmission of the data packet PDU 4.

The error elimination procedure described above then leads to a substantial improvement in the throughput on the HS-DSCH when the four commands ACK, NACK, Revert Cmd or Revert NACK to be transmitted in the uplink are provided with an error protection which takes into account the frequency with which these commands are to be transmitted in real situations, because a higher degree of error protection will always involve an increase in the data quantity to be transmitted (additional redundancy). Accordingly, commands (ACK and NACK) which are to be transmitted frequently should be transmitted with a lower redundancy and accordingly lower error protection than the commands (Revert Cmd, Revert NACK) which are to be transmitted only seldom, because the latter are only necessary for the error elimination situation. An optimization of the throughput may then be achieved in that the required redundancy for protecting the transmission of ACK and NACK is laid down such that on the one hand the incorrect interpretation of ACK as NACK or NACK as ACK will occur only seldom (for example in 1% of all cases) also under unfavorable channel conditions, while on the other hand the redundancy to be transmitted is not substantially higher than required under channel conditions which are not very unfavorable, so as not to raise the interference in the uplink resulting from the transmission to an unnecessarily high level. If unfavorable channel conditions occur for a short time, nevertheless leading to an incorrect interpretation, the error elimination procedure will intervene, which procedure will then not interpret the revert commands incorrectly because of the increased redundancy in spite of continuing unfavorable channel conditions.

In addition, the enhanced error protection of Revert Cmd and Revert NACK takes into account the fact that an incorrect interpretation of Revert Cmd as Revert NACK or vice versa, or of Revert Cmd as ACK/NACK or Revert NACK as ACK/NACK and vice versa should occur with a very low residual probability only, because otherwise the implementation of the error elimination procedure would lead to new error conditions which would not have been present without this procedure.

It is argued at present in 3GPP TSG-RAN-WG1 and WG2 that an ACK or NACK is to be sent for each data block (whose time duration is fixed and is denoted Transmission Time Interval Tmd sent in the DL via the HS-DSCH on the uplink DPCCH-2 (spreading factor 256) associated with the mobile station, depending on whether the mobile station could or could not decode the data block successfully. The TTI for these data blocks usually extends over 3 slots (one radio frame has 15 slots) according to the views prevailing at present. The acknowledgements, which will then also take place in the uplink every 3 slots, have available 10 (repeat)-coded bits, i.e. an ACK would be transmitted by means of 10 (repeat-coded) bits of value 1 via the radio interface, whereas a NACK is to be transmitted with 10 (repeat-coded) bits of the value −1. These 10 coded bits are then additionally spread. This leads to erroneous interpretation probabilities of the order of 1%, depending on the channel conditions. Further bits on the DPCCH-2 are used for other purposes, for example for the transmission of measurement values for characterizing the channel quality level.

The spreading factor on the DPCCH-2 is fixed, i.e. it cannot be dynamically changed from one radio frame to the next or from one TTI or even from one slot to the next. It is accordingly not possible to reduce the spreading factor of the DPCCH-2 (for example to halve it) such that now a clearly improved error-correcting coded revert command (with double the possible data quantity) can be sent in dependence on the occurrence of an erroneous interpretation of NACK as ACK (this is the case in the most unfavorable situations, whereas the erroneous interpretation of ACK as NACK is to be regarded as less critical) in the TTI, in which then one of the revert commands (Revert-Cmd or Revert-NACK) would have to be transmitted.

Error Correction Improvement Utilizing Channel Spreading

To achieve an improvement in the error correction for the transmission of revert commands in the rare case in which a NACK is misinterpreted as an ACK in the base station, the mobile station may switch on an additional previously defined spreading code (spreading factor, for example, also 256), on which this additional redundancy can be transmitted in parallel on the uplink (alternatively: the spreading code is allocated via the HS-DSCH from the start of the data reception, but the additional redundancy is only transmitted if it is necessary). For example, the mobile station could send an ACK in the case of a Revert-Cmd on the DPCCH-2 (the bit sequence used here should not be changed for this), as well as a clearly improved error-correcting coded bit sequence on the additional spreading code which then signifies a Revert-Cmd in cooperation with the ACK on the DPCCH-2. In the case of a Revert-NACK command, the mobile station may furthermore send a NACK on the DPCCH-2 and in addition a clearly improved error-correcting coded bit sequence on the additional spreading code, which will then signify a Revert-NACK in cooperation with the NACK on the DPCCH-2. The base station decides which command was sent from a suitable combination of the data received on the DPCCH-2 and on the additionally provided spreading code.

In dependence on the spreading code which may be applied in the mobile station, the base station must always despread both the spreading code of the DPCCH-2 and the added spreading code in parallel so as to recognize whether an ACK/NACK or one of the revert commands is present. This, however, is not a very complicated additional procedure. The details of the coding of the data on the additional spreading factor will not be considered further here.

The addition of a further spreading code is no serious problem in the UMTS uplink (unlike the downlink, where all mobile stations must share the code tree present). The addition of this spreading code merely has the result that slightly higher requirements must be imposed on the linearity of the power amplifier in the mobile station.

Application of the Technology to an ARQ Protocol without Error Elimination Procedure

Without the error elimination procedure described above, the technology could also be applied only to the transmission of the NACK: whenever the mobile station has to send a NACK, it will send this command with additional redundancy on a further spreading code specially switched on for this. This would very strongly reduce the frequency of an erroneous interpretation of NACK as ACK, so that the error condition of a misinterpretation of NACK as ACK will occur very seldom and an error elimination procedure would no longer be necessary. It is a disadvantage of this solution, however, that it may be expected that a NACK must be sent comparatively frequently, and that the additionally transmitted redundancy is not necessary at all in the case of channel conditions which are not unfavorable, for the purpose of avoiding any misinterpretation. Under these conditions, however, more interference than necessary would be generated in the uplink. It would presumably be more favorable here to increase merely the transmission power for a NACK so as to achieve an improvement in the reliability of the detection decision in this manner.

1. A method of transmitting data packets between a transmitter and a receiver,
wherein the receiver is designed for sending a positive acknowledge message to the transmitter when a data packet is received free from errors,
wherein the receiver is designed for sending a negative acknowledge message to the transmitter when a data packet is received with errors,
wherein the receiver is designed for sending a repeat message to the transmitter for requesting a repeated transmission of a data packet if no repeated transmission of the relevant data packet takes place in spite of a negative acknowledge message sent by the receiver, and
wherein the transmitter is designed for the repeated transmission of a data packet whenever the transmitter has received a negative acknowledge message or a repeat message.

2. A method as claimed in claim 1, characterized in that the transmitter puts those data packets for which it has received a positive acknowledge message into temporary storage for a further transmission period,
wherein a transmission period is the time period between the transmission of a data packet and the reception of a positive or negative acknowledge message or a repeat message.

3. A method as claimed in claim 1, characterized in that the data packets transmitted by the transmitter have a sequence number for distinguishing between a repeat transmission and a first-time transmission.

4. A method as claimed in claim 3, characterized in that the positive and negative acknowledge messages sent by the receiver comprise the sequence number so as to distinguish between a repeat transmission and a first-time transmission.

5. A method as claimed in claim 1, characterized in that a periodically repeating time frame with N time slots is provided, wherein said time slots of a time frame are each reserved for the transmission of one data packet.

6. A method as claimed in claim 1, characterized in that the receiver, after transmitting a negative acknowledge message and subsequently receiving an unexpected data packet, nevertheless puts the latter into temporary storage.

7. A method as claimed in claim 1, characterized in that the receiver, after sending a positive acknowledge message and subsequently receiving an unexpected data packet, does not put the latter into temporary storage.

8. A method as claimed in claim 1, characterized in that the receiver is designed for sending a first repeat message for requesting a repeat transmission of a data packet and for positively acknowledging a non-expected data packet, and in that the receiver is designed for sending a second repeat message for requesting a repeat transmission of a data packet and for negatively acknowledging a non-expected data packet.

9. A data transmission system comprising a transmitter and a receiver and means for transmitting data packets between the transmitter and the receiver,
wherein the receiver is designed for sending a positive acknowledge message to the transmitter when a data packet is received free from errors,
wherein the receiver is designed for sending a negative acknowledge message to the transmitter when a data packet is received with errors,
wherein the receiver is designed for sending a repeat message to the transmitter for requesting a repeated transmission of a data packet if no repeated transmission of the relevant data packet takes place in spite of a negative acknowledge message sent by the receiver, and
wherein the transmitter is designed for the repeated transmission of a data packet whenever the transmitter has received a negative acknowledge message or a repeat message.

10. A method of transmitting data packets between a transmitter and a receiver,
wherein the receiver is designed for sending a positive acknowledge message to the transmitter when a data packet is received free from errors,
wherein the receiver is designed for sending a negative acknowledge message to the transmitter when a data packet is received with errors, and
wherein a first spreading code is provided for sending the positive and the negative acknowledge message, and a second spreading code is provided for sending additional redundancy for the negative acknowledge message.

11. A method of transmitting data packets between a transmitter and a receiver,
wherein the receiver is designed for sending a positive acknowledge message to the transmitter when a data packet is received free from errors,
wherein the receiver is designed for sending a negative acknowledge message to the transmitter when a data packet is received with errors,
wherein the receiver is designed for sending a repeat message to the transmitter for requesting a repeated transmission of a data packet if no repeated transmission of the relevant data packet takes place in spite of a negative acknowledge message sent by the receiver, and
wherein a first spreading code is provided for sending the positive and the negative acknowledge message and the repeat message, and
wherein a second spreading code is provided for sending additional redundancy for the negative acknowledge message and/or the repeat message.

12. A transmitter for transmitting data packets to a receiver, wherein the transmitter is designed for the repeated transmission of a data packet whenever the transmitter has received a negative acknowledge message or a repeat message from a receiver.

13. A receiver for receiving data packets for a transmitter,
wherein the receiver is designed for sending a positive acknowledge message to the transmitter when a data packet is received free from errors,
wherein the receiver is designed for sending a negative acknowledge message to the transmitter when a data packet is received with errors,
wherein the receiver is designed for sending a repeat message to the transmitter for requesting a repeated transmission of a data packet if no repeated transmission of the relevant data packet takes place in spite of a negative acknowledge message sent by the receiver.
